(19) United States
(12) Patent Application Publication
(10) Pub. No.: US 2015/0224401 A1
(43) Pub. Date: Aug. 13, 2015

(54) GAME MANAGEMENT SERVER DEVICE AND GAME MANAGEMENT PROGRAM

(71) Applicant: DeNA Co., Ltd., Tokyo (JP)

(72) Inventors: Takuya HONJO, Tokyo (JP); Shunosuke FUJISAWA, Tokyo (JP); Wataru TAKAHASHI, Tokyo (JP)

(21) Appl. No.: 14/613,681

(22) Filed: Feb. 4, 2015

(30) Foreign Application Priority Data
Feb. 7, 2014 (JP) 2014-022694

(51) Int. Cl. A63F 13/67; A63F 13/822

(52) U.S. Cl. CPC A63F 13/67; A63F 13/822

(57) ABSTRACT

A game management server device includes an evolution processing management unit that evolves base game media into evolved game media by combining them with partner game media in accordance with an evolution material table that includes settings for the base game media, partner game media, evolved game media, and evolution success probabilities, and a player information storage unit that stores, for each player, information on the base game media, partner game media, and the evolution material table belonging to the player, and, the evolution processing management unit, upon receiving instructions to evolve the base game media evolution from the player and for said player owning an evolution material table used for evolving the base game media, as well as the base game media and partner game media configured in said evolution material table, uses the evolution success probabilities configured in said evolution material table to make a determination.

This application claims the benefit of foreign priority under 35 USC 119(a) based on Japanese Patent Application No. 2014-022694, filed Feb. 7, 2014, the contents of which is incorporated herein by reference in its entirety.

### BACKGROUND

1. Technical Field

The present invention relates to a game management server device.

2. Background Art

In the past, evolution into new game media has been accomplished by combining characters and other game media with other game media. Patent Document 1 describes raising the upper limit value of the level of a game card (evolution) by combining two game cards (game media) of the same type.

However, for example, even though evolution does take place in the configuration described in Patent Document 1, the problem is that this evolution is limited to increasing the upper limit values of the parameters of the basic game cards and does not contain an element of surprise.

On the other hand, games are known which use alchemy to produce new items by merging a pair of items (for example, see “Dragon Quest 9” (http://dengekionline.com/elem/000/000/143/143065/ and http://dq9ds.org/saikyou.html)).

### PRIOR ART LITERATURE

### Patent Literature

### [Patent Document 1]

Japanese Patent 5,204,330

### SUMMARY

Although conventional games which use alchemy require obtaining predetermined items in order to use alchemy, alchemy can be used as long as the player knows the contents of the alchemistic recipe, the combination of items, and so forth. For this reason, for example, if the contents of the alchemistic recipe can be learned external to the game, the player can use alchemy based on the alchemistic recipe. For this reason, the problem has been to intensify the player's in-game activities and create more diversity in the game in response to the player's in-game activities.

The present invention has been devised by taking the above-mentioned circumstances into account and it is an object of the invention to provide a technology that can intensify the player's in-game activities and create more diversity in the game in response to the player's in-game activities.

The present invention provides a game management server device that is connected to terminal devices belonging to multiple players over a network, wherein said server device includes an evolution processing management unit that evolves base game media into evolved game media by combining it with partner game media in accordance with an evolution material table that includes settings for the base game media, partner game media, evolved game media, and evolution success probabilities, and a player information storage unit that stores, for each player, information regarding the base game media, the partner game media, and the evolution material table owned by said player, and wherein, along with configuring the first evolved game media and second evolved game media as the evolved game media in the evolution material table, different first evolution success probability and second evolution success probability are respectively associated with the first evolved game media and second evolved game media, and the evolution processing management unit, upon receiving instructions to evolve the base game media are received from the player and in the event that said player owns the evolution material table used for evolving the base game media, as well as the base game media and partner game media configured in said evolution material table, uses the first evolution success probability and second evolution success probability to determine whether to evolve the base game media into either one of the first evolved game media or second evolved game media, or not to evolve the same into either of the above, and presents said determination result to the player, and, in the event it is decided to evolve the base game media into the second evolved game media, upon re-configuration of the evolution success probability of the first evolved game media into a third evolution success probability that is higher than the first evolution success probability, conditional on a process of compensation payment by the player, once again uses the third evolution success probability and second evolution success probability to determine whether to evolve the base game media into either one of the first evolved game media or second evolved game media, or not to evolve the same into either of the above.

It should be noted that discretionary combinations of the constituent elements above, as well as items produced by converting the wording of the present invention into different methods, apparatus, systems, recording media, computer programs (e.g., a non-transitory computer readable medium having machine-executable instructions), and the like, are all valid as embodiments of the present invention.

The present invention can provide a technology capable of intensifying the player's in-game activities and creating more diversity in the game in response to the player's in-game activities.

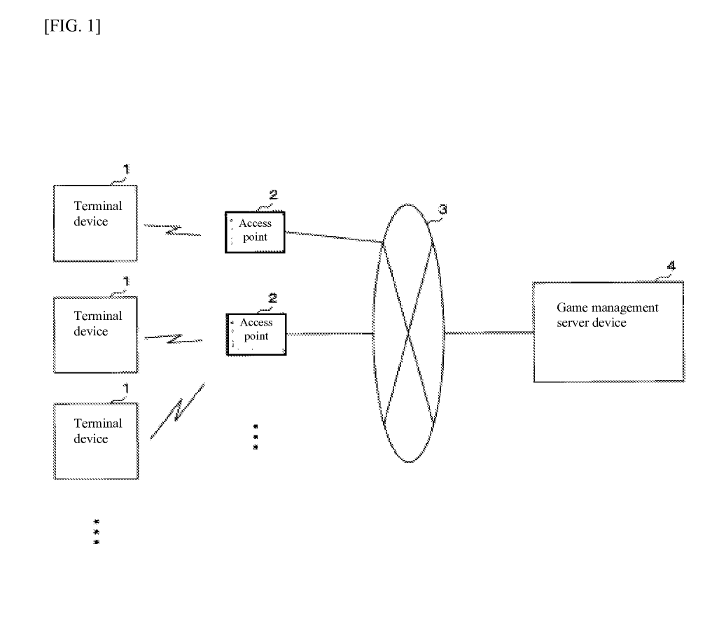

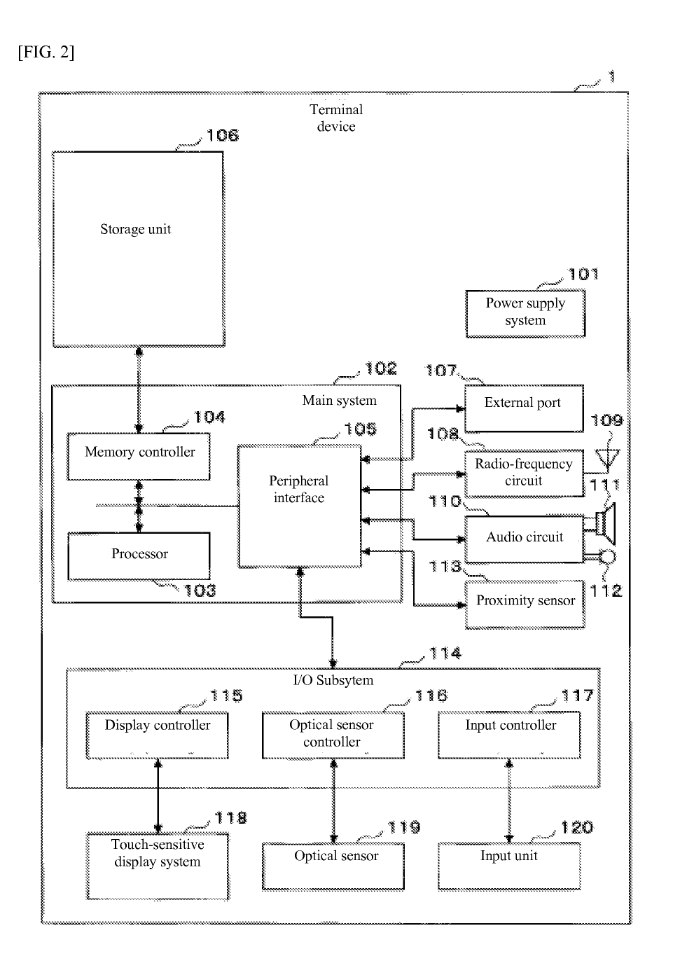

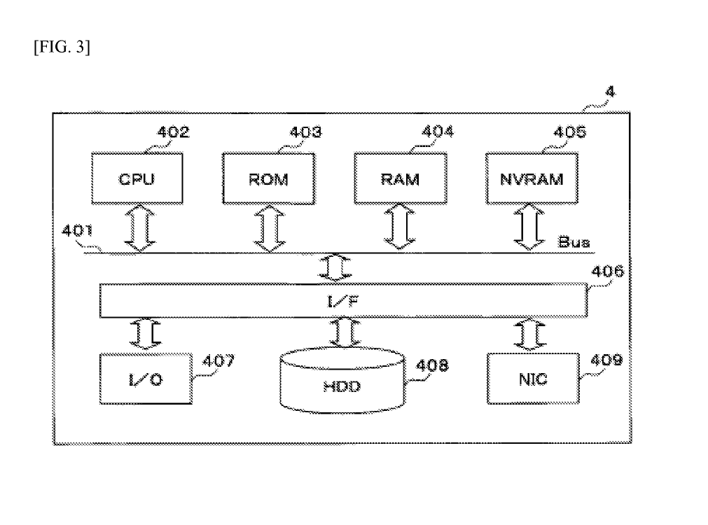

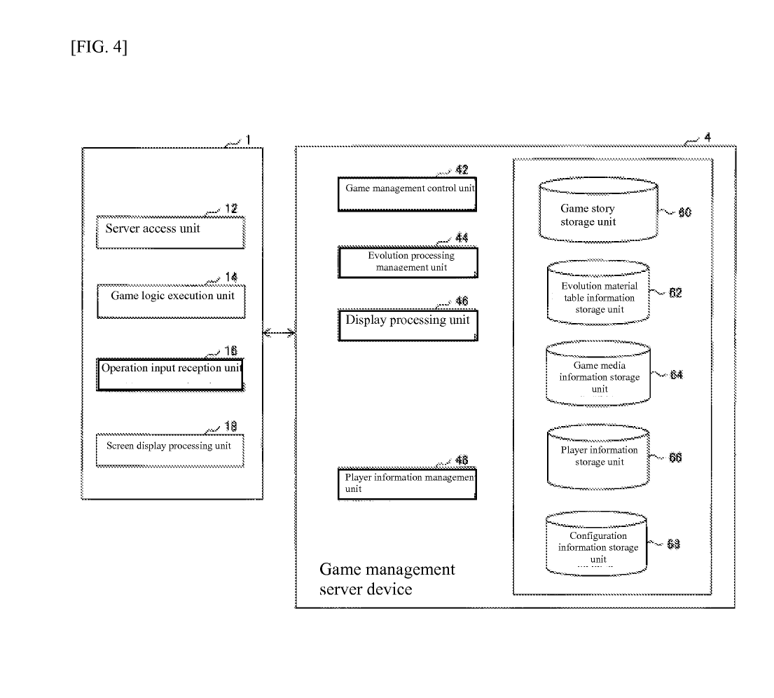

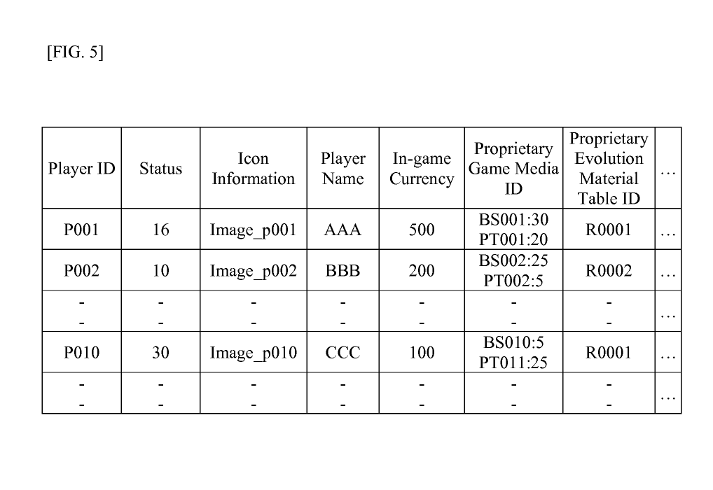

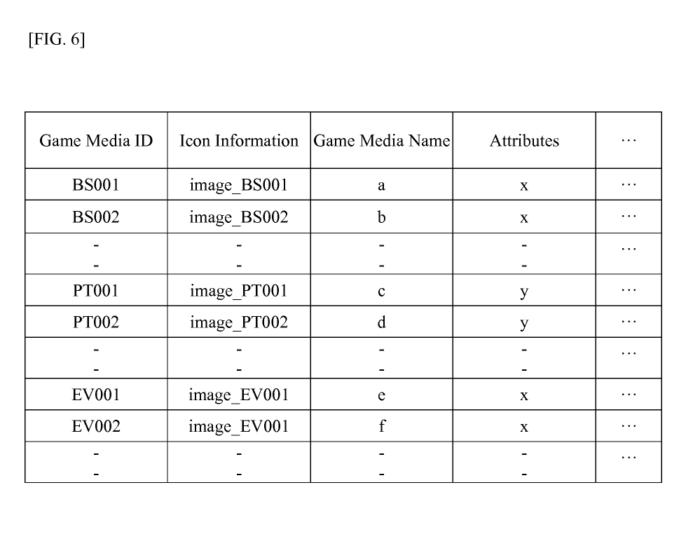

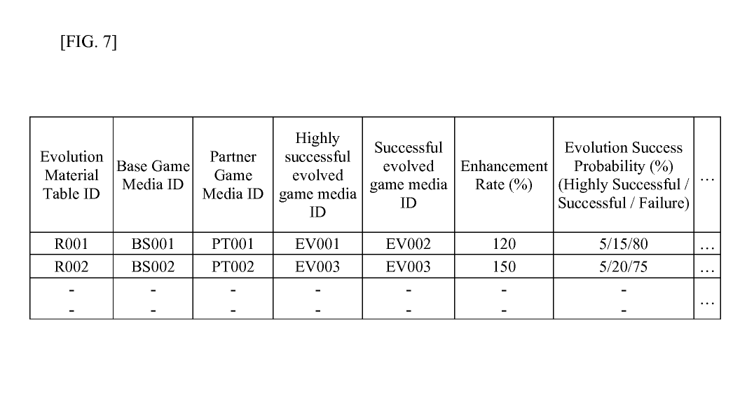

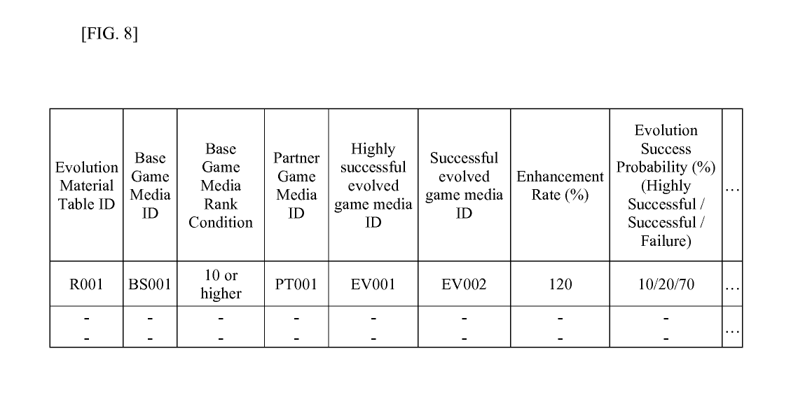

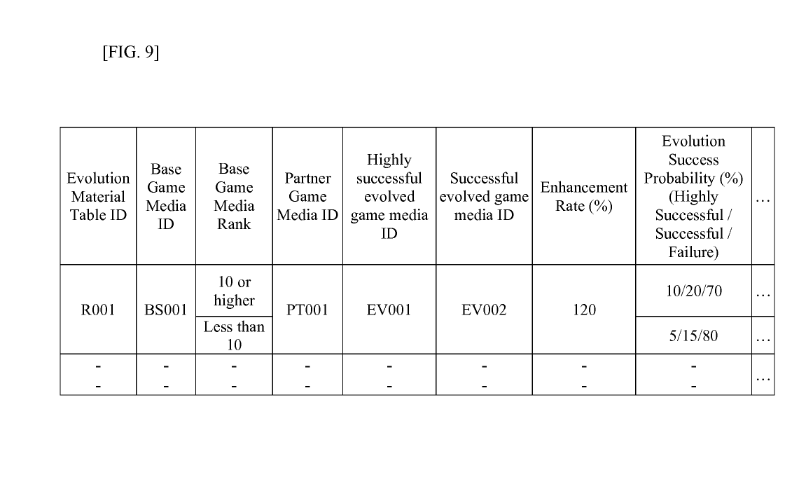

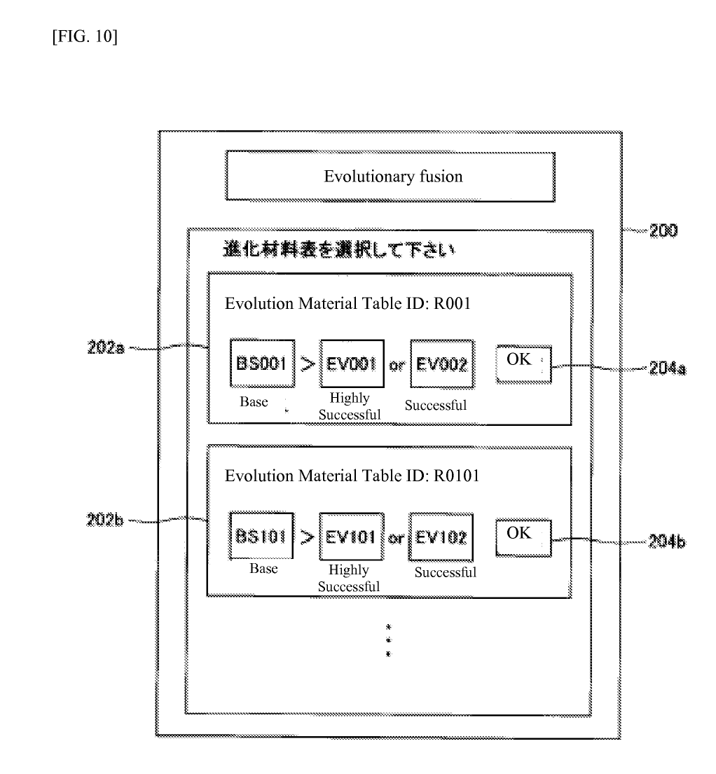

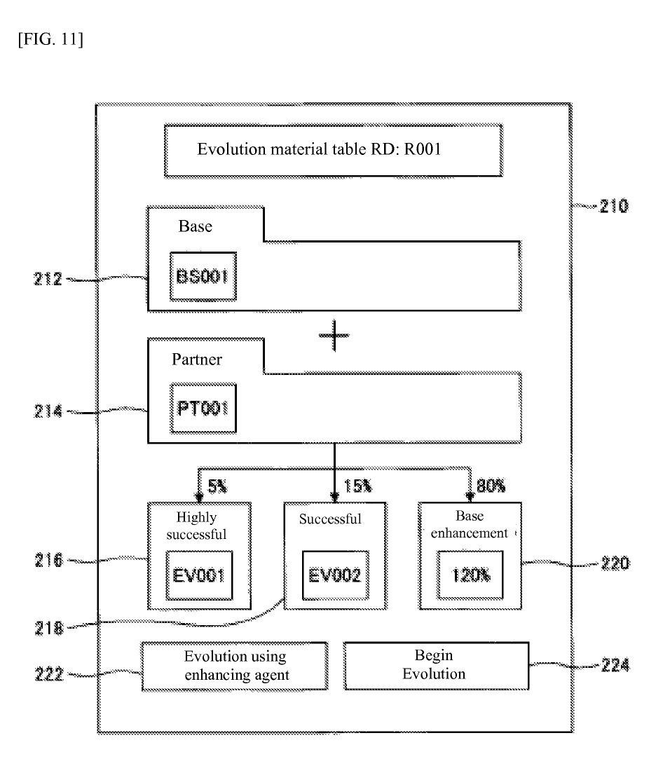

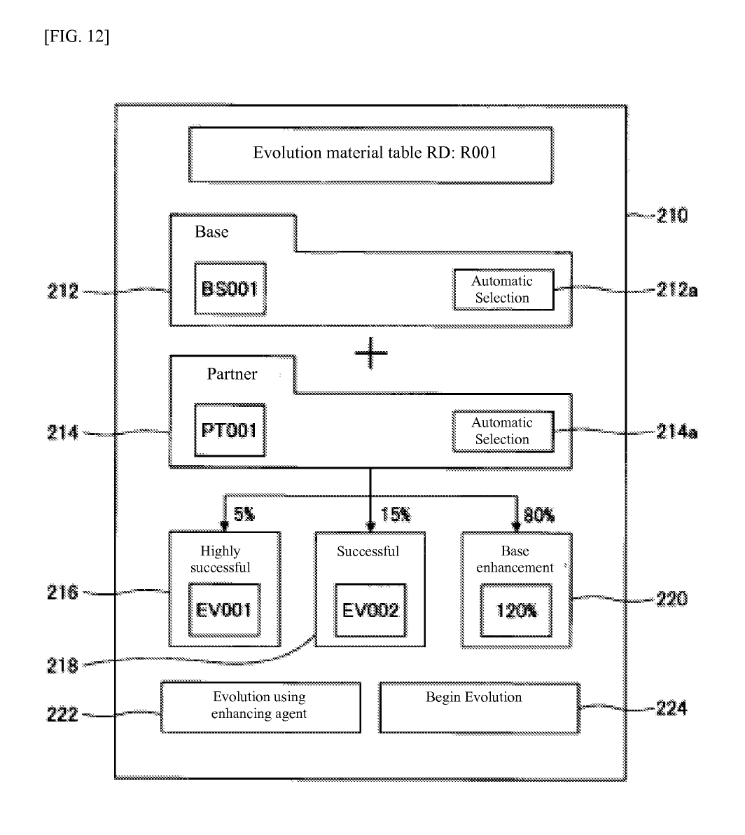

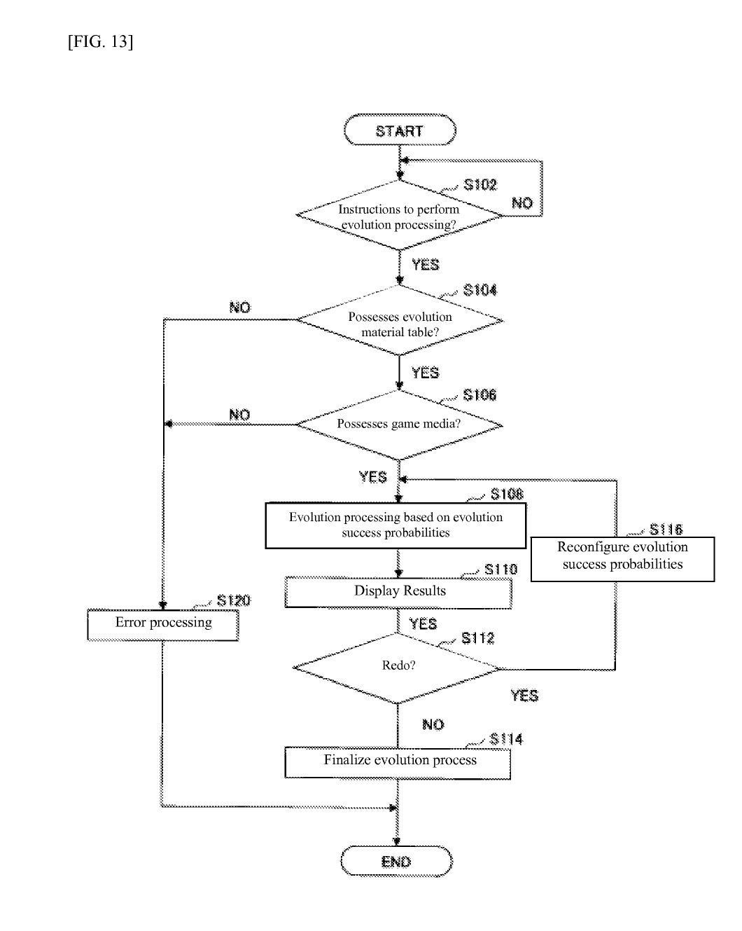

### BRIEF DESCRIPTION OF THE DRAWINGS

[FIG. 1] A block diagram illustrating an example of the system configuration used in the present embodiment.

[FIG. 2] A block diagram illustrating an example of the hardware configuration of the terminal device used in the present embodiment.

[FIG. 3] A block diagram illustrating an example of the hardware configuration of the game management server device used in the present embodiment.

[FIG. 4] A block diagram illustrating an example of the functional configuration of the terminal devices and the game management server device used in the present embodiment.

[FIG. 5] A diagram illustrating an example of the internal configuration of the player information storage unit used in the present embodiment.

[FIG. 6] A diagram illustrating an example of the internal configuration of the game media information storage unit used in the present embodiment.

[FIG. 7] A diagram illustrating an example of the internal configuration of the evolution material table information storage unit used in the present embodiment.

[FIG. 8] A diagram illustrating another example of the internal configuration of the evolution material table information storage unit used in the present embodiment.

[FIG. 9] A diagram illustrating another example of the internal configuration of the evolution material table information storage unit used in the present embodiment.

[FIG. 10] A diagram illustrating an example of the evolution processing screen used in the present embodiment.

[FIG. 11] A diagram illustrating another example of the evolution processing screen used in the present embodiment.

[FIG. 12] A diagram illustrating another example of the evolution processing screen used in the present embodiment.

[FIG. 13] A flow chart illustrating an example of the processing procedure of the game management server device used in the present embodiment.

### DETAILED DESCRIPTION

Embodiments of the present invention will be described below with reference to the drawings. It should be noted that in all of the drawings like reference numerals are used to refer to like constituent elements and, accordingly, a discussion herein is omitted.

FIG. 1 is a block diagram illustrating an example of the system configuration used in the present embodiment.

The system includes terminal devices 1 belonging to players (users), access points 2, such as mobile wireless base stations and Wi-Fi stations, a network 3, such as the Internet, as well as a game management server device 4, which manages (controls) a game that multiple players use to engage in game play over a network. The game management server device 4 is connected to the terminal devices 1 of the multiple players over the network 3. The terminal devices 1 are, for example, mobile phones, smartphones, game consoles, personal computers, touch pads, electronic book readers, and other information processing devices.

FIG. 2 is a block diagram illustrating an example of the hardware configuration of the terminal device 1 used in the present embodiment.

The terminal device 1 includes a power supply system 101, a main system 102, a storage unit 106, an external port 107, a radio-frequency circuit 108, an antenna 109, an audio circuit 110, a speaker 111, a microphone 112, a proximity sensor 113, an I/O subsystem 114, a touch-sensitive display system 118, an optical sensor 119, and an input unit 120. The main system 102 includes a processor 103, a memory controller 104, and a peripheral interface 105. The I/O subsystem 114 includes a display controller 115, an optical sensor controller 116, and an input controller 117.

FIG. 3 is a block diagram illustrating an example of the hardware configuration of the game management server device 4 used in the present embodiment.

The game management server device 4 includes a CPU (Central Processing Unit) 402, a ROM (Read Only Memory) 403, a RAM (Random Access Memory) 404, and an NVRAM (Non-Volatile Random Access Memory) 405, which are connected to a system bus 401; an I/F (Interface) 406; a keyboard, a mouse, a monitor, a CD/DVD (Compact Disk/Digital Versatile Disk) drive, and other I/O devices (Input/Output Device) 407 connected to the I/F 406; a HDD (Hard Disk Drive) 408; and an NIC (Network Interface Card) 409.

FIG. 4 is a block diagram illustrating the functional configuration of the terminal devices 1 and the game management server device 4.

The terminal device 1 includes a server access unit 12, a game logic execution unit 14, an operation input reception unit 16, and a screen display processing unit 18.

The operation input reception unit 16 receives operation input from the player (user) operating the terminal device 1.

The game logic execution unit 14 conducts a game by performing screen transitions in response to operation input received by the operation input reception unit 16,

When access to the game management server device 4 becomes necessary in the course of the processing performed by the game logic execution unit 14, the server access unit 12 transmits a request to the game management server device 4 and receives processing results and the like as a response.

Screen display processing unit 18 generates a screen display under the control of the game logic execution unit 14.

The game management server device 4 includes a game management control unit 42, an evolution processing management unit 44, a display processing unit 46, a player information management unit 48, a game story storage unit 60, an evolution material table information storage unit 62, a game media information storage unit 64, a player information storage unit 66, and a configuration information storage unit 68.

The game story storage unit 60 stores a game story, etc., used to execute the game executed in the present embodiment.

The game management control unit 42 exercises overall control over the game management server device 4. For example, in response to a request from a terminal device 1, the game management control unit 42 refers to the game story storage unit 60, performs processing that matches the game story, and transmits the request processing results to the terminal device 1 as a response.

The game that the present embodiment is concerned with can be configured such that, for example, every player can acquire points by directing characters, such as his or her own player characters, to engage in quests, attacks, boss elimination, and other actions in the game space, with the status of the player raised, or the experience value of the characters increased depending on the acquired points. In addition, it is also possible to use a configuration in which directing a character to perform the above-described actions while outfitted with items such as weapons or other adornments, such as hats and the like, increases the experience value of said weapons and adornments depending on the acquired points. In the present embodiment, the characters, weapons, adornments, and other items are referred to as “game media”.

In the thus configured game, the player can evolve the game media he or she owns into evolved game media by combining it with other game media, etc. at predetermined moments in time. Below, the game media to be evolved are referred to as “base game media”, the other game media to be combined with said base game media are referred to as “partner game media”, and the game media produced as a result of evolving the base game media are referred to as “evolved game media”. For example, it is assumed that evolved game media appear different from unevolved base game media, and that parameters such as power, attack strength, and so forth, along with any special abilities, are also different.

Furthermore, in the present embodiment, it is assumed that for the player to evolve the base game media into evolved game media, along with possessing the base game media and partner game media, the player must also posses an evolution material table that includes settings for at least base game media, partner game media, evolved game media, and evolution success probabilities. It should be noted that each piece of game media and the evolution material table are assumed to be provided based on the player's actions within the game, or provided when the player pays compensation, such as with in-game currency or the like.

The player information storage unit 66 stores various types of player information regarding all of the players participating in the game. In the present embodiment, the player information storage unit 66 stores associated information for multiple players, including information on the base game media, partner game media, and evolution material tables belonging to each player. The player information management unit 48 carries out updating, lookup, and other management operations on the player information stored in the player information storage unit 66.

FIG. 5 is a diagram illustrating an example of the internal configuration of the player information storage unit 66 used in the present embodiment. The player information storage unit 66 uses columns (fields) such as “Player ID”, “Status”, “Icon Information”, “Player Name”, “In-game Currency”, “Proprietary Game Media ID”, and “Proprietary Evolution Material Table ID”.

“Player ID” contains information that identifies (determines the identity of) a player. “Status” indicates said player's status as he or she progresses through the game. “Icon Information” contains information that identifies said player's display icon. “Player Name” contains information on the display name of said player. “In-game Currency” shows the currency owned by said player that can be used in the game.

“Proprietary Game Media ID” contains information on the game media owned by said player. The present embodiment can use a configuration in which experience value parameters indicating the current level of a piece of game media, its time of use, battle winning rate, and other experience values are associated with each piece of game media. For this reason, as shown in FIG. 5, these experience value parameters are also associated with each game media IDs stored in the “proprietary game media ID” field of the player information storage unit 66. For example, for a player having a player ID of “P001”, if a proprietary game media ID is recorded as “BS001: 30”, this indicates that the player has a piece of game media with an experience value parameter of “30” under the game media ID of “BS001”. Accordingly, every player can own multiple pieces of game media with the same game media ID, and the experience value parameters of these pieces of game media may be the same or different. “Proprietary Evolution Material Table ID” contains information on the evolution material table owned by said player.

Going back to FIG. 4, the game media information storage unit 64 stores various types of game media information for all of the game media featured in the game.

FIG. 6 is a diagram illustrating an example of the internal configuration of the game media information storage unit 64 used in the present embodiment. The game media information storage unit 64 uses columns such as “Game Media ID”, “Icon Information”, “Game Media Name”, and “Attributes”.

“Game Media ID” contains information that identifies game media. “Icon Information” contains information that identifies the display icon of said game media. “Game Media Name” contains information on the display name of said game media. “Attributes” shows attributes, such as the type of said piece of game media.

Going back to FIG. 4, the evolution processing management unit 44 uses an evolution material table belonging to the player to control the evolution process, during which the base game media configured in said evolution material table are evolved into evolved game media by combining them with the partner game media.

Specifically, upon receiving instructions to evolve the base game media from the player, the evolution processing management unit 44 refers to the player information storage unit 66 via the player information management unit 48 and determines whether or not said player owns an evolution material table used for evolving the base game media, as well as the base game media and partner game media configured in said evolution material table. If said player owns an evolution material table used for evolving the base game media as well as the base game media and partner game media configured in said evolution material table, the evolution processing management unit 44 uses a lottery based on the evolution success probabilities configured in said evolution material table to determine whether or not to evolve the base game media into evolved game media. Based on the resultant decision, the evolution processing management unit 44 performs evolution processing, such as evolving the base game media into evolved game media in the case of evolution success, or leaving the base game media unchanged as base game media in the case of evolution failure. It should be noted that the present embodiment can use a configuration in which, even in the case of a failure when the base game media is not evolved into any evolved game media, the base game media are enhanced, e.g. the experience value parameters of the base game media are increased.

Furthermore, the evolution processing management unit 44 updates and references information in the player information storage unit 66 via the player information management unit 48. In the present embodiment, it is assumed that if evolution processing is executed, the partner game media are consumed both in the case of an evolution success and in the case of an evolution failure. In addition, in case of an evolution success, the base game media are consumed and the freshly evolved game media are provided to the player. In the case of an evolution failure, it is assumed that the base game media remain in the player's possession, and only the experience value parameters of the base game media are updated. Accordingly, if evolution success-related evolution processing is performed, the evolution processing management unit 44 deletes information on the corresponding base game media and partner game media from said player's Proprietary Game Media ID column in the player information storage unit 66 and adds information on the evolved game media. Also, if evolution failure-related evolution processing is performed, the evolution processing management unit 44 deletes information on the corresponding partner game media from said player's Proprietary Game Media ID column in the player information storage unit 66 and overwrites the experience value parameters of the base game media. It should be noted that a configuration can be used in which the evolution material table is not deleted in any case even when evolution processing is carried out. In another example, a configuration may be used in which the evolution material table is consumed whenever evolution processing is performed. In addition, the evolution processing management unit 44 updates and references information in the evolution material table information storage unit 62 and game media information storage unit 64.

In other words, in the present embodiment, evolution processing is carried out based on an evolution material table, conditional on the player's owning said evolution material table. In addition, a lottery based on the evolution success probabilities configured in the evolution material table is used to determine whether or not the evolution processing succeeds and the base game media is evolved into evolved game media. As a result of using such a configuration, the player cannot carry out evolution processing without obtaining an evolution material table, and, in addition, must also obtain the base game media and partner game media configured in the evolution material table, which can intensify the player's in-game activities, or create diversity to the game in response to the player's in-game activities. In addition, since evolution processing succeeds or fails based on the evolution success probabilities configured in the evolution material table, this can provide an element of surprise to the player.

Furthermore, in the present embodiment, there can be provided multiple evolved game media candidates for evolution from base game media. Specifically, in the present embodiment, each evolution material table can use a configuration in which a first evolved game media and a second evolved game media are set up as evolved game media, and a configuration in which different first evolution success probability and second evolution success probability are respectively associated with a first evolved game media and a second evolved game media.

Based on the evolution material table, the evolution processing management unit 44 uses a lottery based on the first evolution success probability and second evolution success probability configured in the evolution material table to determine whether to evolve the base game media into either one of the first evolved game media and second evolved game media, or not to evolve it into either of the above (failure). In other words, in the present embodiment, if the player owns an evolution material table used for evolving the base game media, as well as the base game media and partner game media configured in said evolution material table, the result (i.e. whether the base game media evolve (success) or do not evolve (failure) into the first evolved game media or second evolved game media) is obtained in accordance with a lottery based on the evolution success probabilities configured in the evolution material table.

Here, it is assumed that the first evolved game media has a higher power, functionality level, or degree of rarity than the second evolved game media. For this reason, a result wherein the base game media is evolved into a first evolved game media in accordance with a lottery based on the evolution success probabilities configured in the evolution material table is referred to as “highly successful”, a result wherein the game media is evolved into a second evolved game media is referred to as “successful”, and a result wherein the game media is not evolved into either of the above is referred to as a “failure”.

In this manner, providing multiple evolved game media candidates subject to evolution from base game media can provide an element of surprise to the player.

The evolution material table information storage unit 62 stores various types of evolution material table information for all of the evolution material tables. FIG. 7 is a diagram illustrating an example of the internal configuration of the evolution material table information storage unit 62 used in the present embodiment. The evolution material table information storage unit 62 uses columns such as “Evolution Material Table ID”, “Base Game Media ID”, “Partner Game Media ID”, “Highly Successful Evolved Game Media ID”, “Successful Evolved Game Media ID”, “Rate of Enhancement (%)”, and “Evolution Success Probability (%)”.

“Base Game Media ID” contains information identifying base game media. “Partner Game Media ID” contains information identifying partner game media.

The columns “Highly Successful Evolved Game Media ID” and “Successful Evolved Game Media ID” contain information identifying evolved game media obtained by highly successful evolution and evolved game media obtained by successful evolution as a result of combining the corresponding base game media with the partner game media.

The column “Rate of Enhancement (%)” contains information indicating the rate (%) at which the experience value parameters of the base game media are increased in the case of a failure when the base game media is not evolved into any evolved game media. For example, if the experience value of the base game media prior to evolution processing is “30” and the rate of enhancement is 120%, then the experience value parameter of the base game media after evolution processing will be “36”.

The column “Evolution Success Probability” contains information indicating the probability of success during evolution processing. The probability of highly successful evolution, the probability of successful evolution, and the probability of evolution failure are configured here. For example, the fact that the evolution success probabilities (%) are shown to be “5/15/80” in an evolution material table with an evolution material table ID of “R001” means that the probability of highly successful evolution, the probability of successful evolution, and the probability of evolution failure are respectively 5%, 15%, and 80%. It should be noted that since the probability of evolution failure is a value obtained by subtracting the sum of the probability of highly successful evolution and the probability of successful evolution from 100%, it may be left unconfigured in the evolution material table information storage unit 62.

Furthermore, different evolution success probabilities may be established depending on the evolution material table for the same combination of base game media, partner game media, and evolved game media. Accordingly, the player's motivation to obtain various evolution material tables can be increased, the player's in-game activities can be intensified, and greater diversity can be created in the game in response to the player's in-game activities.

Furthermore, in another example, a configuration can be used in which it is assumed that in order for evolution processing to be carried out, the experience value parameters of the base game media and/or partner game media have to be at or above a predetermined level, and the corresponding conditions are configured in the evolution material table. In such a case, a configuration can be used in which experience value parameter-related conditions required for the evolution of the base game media are configured in the evolution material table for at least one of the base game media and partner game media. In other words, a configuration can be used in which evolution processing cannot be carried out if the experience value parameters of at least one of the base game media and partner game media do not meet the conditions configured in the evolution material table. It should be noted that it is possible to configure the experience value parameter-related conditions that are respectively required for both the base game media and partner game media.

Suggested conditions include, for example, that the current level of the game media is at or above a predetermined value, the duration of use of the game media is above a predetermined time, the battle winning rate of the game media is at or above a predetermined value, and so on. Such conditions can be stored in the evolution material table information storage unit 62 in advance, and the evolution processing management unit 44 can determine whether the game media owned by each player meet the conditions by referring to the evolution material table information storage unit 62 and player information storage unit 66. This will be discussed below with reference to FIG. 8.

FIG. 8 is a diagram illustrating another example of the internal configuration of the evolution material table information storage unit 62 used in the present embodiment.

In addition to the columns discussed with reference to FIG. 7, the evolution material table information storage unit 62 contains the column “Base Game Media Rank Condition”. The column “Base Game Media Rank condition” shows the conditions related to the experience value parameters of the base game media required for the evolution of the base game media. Here, “10 or higher” is configured as the “Base Game Media Rank Condition” for the base game media.

If the player owns an evolution material table used for evolving the base game media, as well as the base game media and partner game media configured in said evolution material table, and, at the same time, the rank of the base game media is 10 or higher, then the evolution processing management unit 44, upon receiving instructions to evolve the base game media from the player, uses a lottery based on the evolution success probabilities configured in said evolution material table to determine whether or not to evolve the base game media into evolved game media.

Configuring the experience value parameter-related conditions of the base game media and/or partner game media as a requirement for evolution processing in this manner makes it possible to increase the degree of difficulty of evolution processing, thereby intensifying the player's in-game activities or creating more diversity in the game in response to the player's in-game activities.

In addition, in yet another example, evolution success probabilities may be varied depending on the experience value parameters of the base game media and partner game media used in evolution processing. In such a case, a configuration can be used in which, along with configuring a first experience value parameter condition and a second experience value parameter condition for at least one of the base game media and partner game media in the evolution material table, different evolution success probabilities are associated with the first experience value parameter condition and second experience value parameter condition. Here, a configuration can be used in which, if the first experience value parameter condition is assumed to specify experience values higher than those of the second experience value parameter condition, then an evolution success probability higher than the one used for the second experience value parameter condition is associated with the first experience value parameter condition. This will be discussed below with reference to FIG. 9.

FIG. 9 is a diagram illustrating another example of the internal configuration of the evolution material table information storage unit 62 used in the present embodiment.

In addition to the columns discussed with reference to FIG. 7, the evolution material table information storage unit 62 contains the column “Base Game Media Rank”. The column “Base Game Media Rank” lists experience value parameter-related conditions for the base game media. Here, for example, “10 or higher” and “less than 10” are configured as the “Base Game Media Ranks” in an evolution material table with an evolution material table ID of “R001”, with different evolution success probabilities associated therewith. Namely, “10 or higher” evolution success probabilities (highly successful/successful/failure) “10/20/70”, which have higher experience values, are configured to be higher than “less than 10” evolution success probabilities “5/15/80”, which have lower experience values.

If the player owns an evolution material table used to evolve the base game media, as well as the base game media and partner game media configured in said evolution material table, then the evolution processing management unit 44, upon receiving instructions to evolve the base game media from the player, uses a lottery based on evolution success probabilities associated with the first experience value parameter condition or second experience value parameter condition, to which the experience value parameters of at least one of the base game media and partner game media correspond, in order to determine whether or not to evolve the base game media into evolved game media.

In this manner, during evolution processing, the player's in-game activities are intensified, or more diversity is created in the game in response to the player's in-game activities by changing the evolution success probabilities in accordance with the experience value parameters of the game media used.

Going back to FIG. 4, the display processing unit 46 displays an evolution processing screen used to evolve the base game media under the control of the evolution processing management unit 44. The evolution processing management unit 44 carries out processing intended to present various types of information on the display processing unit 46.

FIG. 10 is a diagram illustrating an example of an evolution processing screen 200 displayed by the display processing unit 46. A list of material table information 202a and 202b from the evolution material tables belonging to said player is displayed on the evolution processing screen 200. Information indicating the base game media, information indicating evolved game media obtained when evolution processing is highly successful, information indicating evolved game media obtained when evolution processing is successful, OK buttons 204a and 204b, and the like are displayed in the material table information 202a, 202b. When the player pushes either of the OK buttons 204a, 204b indicated in the material table information, the display processing unit 46 displays more detailed information on said evolution material table. Specifically, the display processing unit 46 displays the base game media, partner game media, evolved game media, and evolution success probabilities configured in the evolution material table, as well as evolution instruction buttons, to the player in accordance with the evolution material table belonging to the player.

FIG. 11 is a diagram illustrating an example of an evolution processing screen 210 that the display processing unit 46 displays on the evolution processing screen 200 shown in FIG. 10 when the player pushes the OK button 204a shown in the material table information 202a.

Information indicating the base game media 212, configured in an evolution material table with an evolution material table ID of “R001”, information indicating partner game media 214, information indicating evolved game media obtained in case of highly successful evolution 216, information indicating evolved game media obtained in case of successful evolution 218, and information indicating the rate of enhancement at which the base game media is enhanced in case of failure 220 are displayed on the evolution processing screen 210. A configuration can be used in which an icon of the corresponding game media is displayed in each information element. FIG. 11 contains records such as “BS001” and the like, and if, for example, the game media are hats, then images of hats are displayed. Furthermore, the respective probabilities of 5%, 15% and 80% corresponding to highly successful evolution, successful evolution, and evolution failure, a Begin Evolution button 224 used to carry out instructions regarding evolution, and so forth are displayed on the evolution processing screen 210. The evolution processing management unit 44 accepts a depression of the Begin Evolution button 224 as an instruction to perform evolution processing of the base game media.

Furthermore, a button 222 used to perform evolution processing with the help of an enhancing agent is displayed on the evolution processing screen 210. If the player has an item called an “enhancing agent”, he or she can use the enhancing agent during evolution processing. When an enhancing agent is used, the probability that evolution processing will be successful (or highly successful) is set to be high. The player information storage unit 66 can store information identifying enhancing agents as proprietary game media IDs. The evolution success probabilities obtained when using enhancing agents can be pre-configured in each evolution material table, and, in addition, can be pre-configured in the configuration information storage unit 68 as common information in all of the evolution material tables. When the player pushes the button 222, which is used for evolution processing using enhancing agents, the evolution processing management unit 44 refers to said player's player information storage unit 66, and, if said player owns an enhancing agent, conducts a lottery based on the evolution success probabilities obtained when using the enhancing agent. In such a case, the enhancing agent is consumed.

FIG. 12 is a diagram illustrating another example of the evolution processing screen 210 shown in FIG. 11.

Automatic Selection buttons 212a and 214a used for automatically selecting the base game media and partner game media used in evolution processing from information indicating base game media 212 and information indicating partner game media 214 are displayed on the evolution processing screen 210 shown in FIG. 12.

In the present embodiment, as explained with regard to FIG. 8 and FIG. 9, in the event that the experience value parameters of the base game media and/or partner game media are required to be at or above a predetermined level as a condition for evolution processing, or evolution success probabilities vary according to the experience value parameters of the base game media and/or partner game media, the player may sometimes want to select game media with particular experience value parameters, as conditions and circumstance warrant, if he or she has multiple game media with different experience value parameters, even though the game media may be the same. FIG. 12 illustrates an evolution processing screen 210 that the player uses to select the game media used in evolution processing.

For example, a list of game media identified by the game media IDs owned by the player can be displayed when said player clicks on the icons designated as “BS001”, “PT001”, etc. in the information indicating base game media 212 and information indicating partner game media 214. Here, the experience value parameters of each piece of game media can also be displayed in the list. The game media that the player selects from the displayed list is selected as game media used in evolution processing. On the other hand, if the player pushes the Automatic Selection buttons 212a and 214a, the evolution processing management unit 44 selects the game media used in evolution processing. In such a case, for example, the game media having the highest experience value parameters can be selected.

In addition, in another example, the icons of game media having different experience value parameters (not shown) can be displayed together with experience value parameters in the information indicating base game media 212 and information indicating partner game media 214. In such a case, the evolution success probabilities corresponding to the experience value parameters can be displayed when the player clicks on either of the icons in the information indicating base game media 212 and information indicating partner game media 214. Accordingly, the player can select which game media to use by looking at the displayed evolution success probabilities.

In addition, in the present embodiment, the evolution processing management unit 44 presents the result of a decision made based on the evolution success probabilities (first evolution success probability and second evolution success probability) to the player, and if it has been decided to evolve the base game media not into highly successful evolved game media, but into successful evolved game media, the decision can be revised, conditional on a process of compensation payment by the player. In such a case, the evolution processing management unit 44 can conduct a lottery upon re-configuring the evolution success probability of highly successful evolved game media into an evolution success probability (third evolution success probability) that is higher than the evolution success probability prior to revision (first evolution success probability). The compensation conditions required for revision and the issue of how much the evolution success probability should be increased in case of revision can be pre-configured in each evolution material table, and also can be pre-configured in the configuration information storage unit 68 as common information in all of the evolution material tables. In addition, the evolution success probability can be adapted to increase, for example, whenever decision revision-related instructions are carried out and a predetermined compensation is paid. It should be noted that even when a configuration is used in which the evolution material table is consumed each time evolution processing is performed, adopting a configuration in which the evolution material table is not consumed during the revision of the above-described decision (no need for a new evolution material table) allows for the revision of the decision to work more efficiently during the game.

The compensation, as used herein, can be represented, for example, by in-game currency. In addition, in another example, it can also be assumed that the compensation is, for example, something other than in-game currency, such as items obtained within the game. In addition, the compensation required for the revision of the decision may be adapted to change depending on a period of time. Such settings are stored, for example, in the configuration information storage unit 68. The configuration information storage unit 68 stores various types of such configuration information.

If the player issues decision revision-related instructions, conditional on a compensation payment process, the evolution processing management unit 44, performs processing to subtract the amount configured as the compensation required for revision from said player's “in-game currency” in the player information storage unit 66. In addition, it is assumed that in a configuration that enables such revision of the decision, processing up to the point where evolution processing is finalized, is considered as interim processing, and there is no need to prepare new base game media or partner game media at the time of revision.

FIG. 13 is a flow chart illustrating an example of the processing procedure of the game management server device 4 used in the present embodiment. FIG. 13 shows the processing procedure used when the game management server device 4 performs evolution processing on the base game media during the game.

When instructions regarding evolution processing are issued by the player (YES in Step S102), the evolution processing management unit 44 refers to the player information storage unit 66 and determines whether or not said player owns an evolution material table (Step S104). If the player owns an evolution material table (YES in Step S104), the evolution processing management unit 44 refers to the player information storage unit 66 and determines whether or not said player owns the base game media and partner game media configured in said evolution material table (Step S106). If the player owns the base game media and partner game media (YES in Step S106), the evolution processing management unit 44 conducts a lottery based on the evolution success probabilities of said evolution material table, displaying results as highly successful evolution, successful evolution, or failure (Step S108 and Step S110).

When revision instructions are issued by the player (YES in Step S112), the evolution processing management unit 44 re-configures the evolution success probabilities (Step S116) and processes Step S108 and Step S110. Namely, it conducts a lottery based on the re-configured evolution success probabilities and displays results as highly successful evolution, successful evolution, or failure. If no revision is performed in Step S112 (NO in Step S112), the evolution processing management unit 44 finalizes evolution processing (Step S114) and terminates the process. If the evolution processing is finalized and is successful, the evolution processing management unit 44 deletes information on the base game media and partner game media used for evolution from said player's proprietary game media ID column in the player information storage unit 66 and adds information on the evolved game media to the said player's proprietary game media ID column. In addition, if the experience value parameters of the base game media are increased in case of evolution processing failure, the experience value parameters of the base game media used for evolution are updated and information on the partner game media used for evolution is deleted.

If it is found in Step S104 or Step S106 that the player does not own an evolution material table or game media (NO in Step S104 or NO in Step S106), the evolution processing management unit 44 issues an error notification to the effect that evolution processing cannot be done (Step 5120) and terminates the process.

As described above, the game management server device 4 of the present embodiment can provide a technology capable of intensifying the player's in-game activities and creating more diversity in the game in response to the player's in-game activities.

It should be noted that the constituent elements of the terminal devices 1 and game management server device 4 shown in FIG. 4 are a block of functional units, rather than a configuration of hardware units. The constituent elements of the terminal devices 1 and game management server device 4 are implemented using discretionary combinations of hardware and software centered on a networking interface, such as a computer CPU, memory, software programs (e.g., a non-transitory computer readable medium having machine-executable instructions) which are loaded into the memory and which implement the constituent elements of this drawing, and storage units such as hard disks used for storing these programs. The method and apparatus of implementation permit various modifications that can be readily appreciated by a person skilled in the art. In addition, a configuration may be used in which the functions performed by the game management server device 4 are distributed among multiple devices so that they do not necessarily have to be executed by a single device.

Although embodiments of the present invention have been discussed above with reference to drawings, they are merely illustrations of the present invention, and various configurations different from the ones described above can be employed as well.

For example, when evolving the base game media, multiple partner game media may be required. In such a case, experience value parameter conditions for each piece of partner game media may be configured. In addition, when the base game media are evolved, certain evolution materials (i.e. game cards and other items) may also be required in addition to the partner game media. Information regarding these materials is configured in the evolution material table.

Furthermore, instead of configuring the IDs of individual pieces of partner game media as partner game media in the evolution material table, it is possible to pre-configure the attributes of the game media and enable the use of the partner game media that the attributes correspond to.

Furthermore, the game management server device 4 can provide functionality for increasing the experience value parameters of said game media not only via evolution processing using evolution material tables, but also by combining the game media belonging to the player with other game media. Such settings can be stored in advance in the configuration information storage unit 68. In other words, even if the player does not have an evolution material table, the level of the base game media can be increased as long as he or she has predetermined base game media and partner game media. On the other hand, if he or she has an evolution material table, then, for example, in case of using the same base game media and partner game media, a successful evolution process makes it possible to obtain evolved game media, and even in case of failure, the level of the base game media can be increased in the same manner as when the player does not have an evolution material table. For this reason, it is advantageous for the player to have an evolution material table, which can increase the motivation to acquire an evolution material table.

In addition, the game may be executed using either as a “browser-type” game or an “application-type” game. In the browser-type game, the game management server device 4 manages screen transition information (view information), which is a description of display control content in a series of consecutive screens displayed as the game progresses, transmits HTML data documents as well as images and other data associated therewith to the terminal devices in response to data acquisition requests that accompany input operations performed on the terminal devices 1, and carries out processing for displaying them in a web browser on the terminal devices 1. In the application-type game, a piece of game application software (application software) is downloaded to a terminal device 1 from the game management server device 4 in advance, whereupon the game application software is run on the terminal device 1, and screen information is generated and displayed based on screen transition information contained in the game application software downloaded and stored on the terminal device 1 and data acquired from the server when input operations are performed.

### DESCRIPTION OF THE REFERENCE NUMERALS

1 Terminal device
2 Access point
3 Network
4 Game management server device
12 Server access unit
14 Game logic execution unit
16 Operation input reception unit
18 Screen display processing unit
42 Game management control unit
44 Evolution processing management unit
46 Display processing unit
48 Player information management unit
60 Game story storage unit
62 Evolution material table information storage unit
64 Game media information storage unit
66 Player information storage unit
68 Configuration information storage unit
200 Evolution processing screen
210 Evolution processing screen

1. A game management server device connected to terminal devices belonging to multiple players over a network, wherein said game management server device includes:
an evolution processing management unit that evolves base game media into evolved game media by combining it with partner game media in accordance with an evolution material table that includes settings for the base game media, partner game media, evolved game media, and evolution success probabilities, and
a player information storage unit that stores, for each player, information regarding the base game media, partner game media, and the evolution material table owned by said player, and wherein,
along with configuring a first evolved game media and a second evolved game media as the evolved game media in the evolution material table, different first evolution success probability and second evolution success probability are respectively associated with the first evolved game media and second evolved game media, and
the evolution processing management unit, upon receiving instructions to evolve the base game media from the player and in the event that said player owns the evolution material table used for evolving the base game media, as well as the base game media and partner game media configured in said evolution material table, uses the first evolution success probability and second evolution success probability to determine whether to evolve the base game media into either one of the first evolved game media or second evolved game media, or not to evolve the same into either of the above, and presents said determination result to the player, and, in the event it is decided to evolve the base game media into the second evolved game media, upon re-configuration of the evolution success probability of the first evolved game media into a third evolution success probability that is higher than the first evolution success probability, conditional on a process of compensation payment by the player, once again uses the third evolution success probability and second evolution success probability to determine whether to evolve the base game media into either one of the first evolved game media or second evolved game media, or not to evolve the same into either of the above.

2. The game management server device according to claim 1, wherein:
experience value parameters indicating the experience values of the base game media and partner game media are associated with said game media,
experience value parameter-related conditions required for the evolution of said base game media are configured for at least one of the base game media and partner game media in an evolution material table, and
if said player owns an evolution material table used for evolving said base game media, as well as the base game media and partner game media configured in said evolution material table, and, furthermore, at least one of the base game media and partner game media meets the experience value parameter-related conditions configured in said evolution material table, then, upon receiving instructions regarding base game media evolution from the player, the evolution processing management unit uses the first evolution success probability and second evolution success probability to determine whether to evolve the base game media into either one of the first evolved game media or second evolved game media, or not to evolve the same into either of the above.

3. The game management server device according to claim 1, wherein:
the experience value parameters indicating the experience values of the base game media and partner game media are associated with at least one type of said media,
along with configuring a first experience value parameter condition and a second experience value parameter condition for at least one of the base game media and partner game media in the evolution material table, different first evolution success probability and second evolution success probability are respectively associated with the first experience value parameter condition and second experience value parameter condition, and,
if said player owns an evolution material table used for evolving said base game media, as well as the base game media and partner game media configured in said evolution material table, the evolution processing management unit, upon receiving instructions regarding base game media evolution from the player, uses the first evolution success probability and second evolution success probability associated with the first experience value parameter condition or second experience value parameter condition, to which the experience value parameters of at least one of the base game media and partner game media correspond, in order to determine whether to evolve the base game media into either one of the first evolved game media and second evolved game media, or not to evolve the same into either of the above.

4. The game management server device according to claim 3, wherein the condition stipulating higher experience values among the first experience value parameter condition and second experience value parameter condition in the evolution material table is associated with higher evolution success probabilities.

5. The game management server device according to claim 1 that receives instructions regarding media evolution, wherein said device further includes a display processing unit that uses the player's evolution material table to display to the player the base game media, partner game media, and evolved game media configured in said evolution material table, as well as evolution success probabilities and an evolution instruction button, and wherein the evolution processing management unit receives depressions of the evolution instruction button as instructions regarding base game media evolution.

6. A non-transitory computer readable medium having machine-executable instructions for game management, that directs a computer operating as a game management server device connected to terminal devices belonging to multiple players over a network, the machine-executable instructions comprising:
evolving base game media into evolved game media by combining it with partner game media in accordance with an evolution material table that includes settings for the base game media, partner game media, evolved game media, and evolution success probabilities, and
storing, for each player, information regarding the base game media, partner game media, and the evolution material table owned by said player, wherein
along with configuring a first evolved game media and a second evolved game media as the evolved game media in the evolution material table, different first evolution success probability and second evolution success probability are respectively associated with the first evolved game media and second evolved game media, and
wherein the evolving, upon receiving instructions to evolve the base game media from the player and in the event that said player owns the evolution material table used for evolving the base game media, as well as the base game media and partner game media configured in said evolution material table, uses the first evolution success probability and second evolution success probability to determine whether to evolve the base game media into either one of the first evolved game media or second evolved game media, or not to evolve the same into either of the above, and presents said determination result to the player, and, in the event it is decided to evolve the base game media into the second evolved game media, upon re-configuration of the evolution success probability of the first evolved game media into a third evolution success probability that is higher than the first evolution success probability, conditional on a process of compensation payment by the player, once again uses the third evolution success probability and second evolution success probability to determine whether to evolve the base game media into either one of the first evolved game media or second evolved game media, or not to evolve the same into either of the above.
